(19) United States
(12) Patent Application Publication
(10) Pub. No.: US 2019/0102959 A1
(43) Pub. Date: Apr. 4, 2019

(54) SYSTEMS AND METHODS TO DETECT ABNORMALITIES IN A VEHICLE SUSPENSION SYSTEM

(71) Applicant: GM GLOBAL TECHNOLOGY OPERATIONS LLC, Detroit, MI (US)

(72) Inventors: Brian K. Saylor, South Lyon, MI (US); Branton E. Dennis, IV, Howell, MI (US); Robert P. Marble, White Lake, MI (US); Nojan Medinei, Toronto (CA)

(21) Appl. No.: 15/719,978

(22) Filed: Sep. 29, 2017

(51) Int. Cl. G07C 5/08; B60G 17/019; G07C 5/00

(52) U.S. Cl. CPC G07C 5/0808; B60G 17/01908; B60G 2600/042; B60G 2400/102; B60G 2400/252; G07C 5/006

(57) ABSTRACT

An exemplary method to detect a wear condition of a suspension system component of a vehicle includes the steps of receiving suspension system component data from a vehicle sensor, calculating an amplitude of the suspension system component data as a function of frequency, monitoring the amplitude of the suspension system component data within a predetermined frequency range, determining whether the amplitude of the suspension system component data is greater than a predetermined threshold, and, if the amplitude is greater than the predetermined threshold, transmitting a diagnostic notification.

The present invention relates generally to the field of vehicles and, more specifically, to systems and methods to detect abnormalities in one or more components of a vehicle suspension system.

Dampers and other suspension components can degrade or fail suddenly and at different intervals and are considered a safety issue with regard to vehicle handling. However, the state of health of suspension components, including vehicle damper system components, is often not identified by the vehicle operator until the component has degraded to a point where the suspension component or other vehicle components may be damaged.

### SUMMARY

Embodiments according to the present disclosure provide a number of advantages. For example, embodiments according to the present disclosure enable detection of abnormalities in vehicle suspension components, such as vehicle dampers or shock absorbers, by correlating suspension system data received from one or more vehicle sensors with an expected suspension system response to a known road input event.

In one aspect, a method to detect a wear condition of a suspension system component of a vehicle includes the steps of receiving suspension system component data from a vehicle sensor, calculating an amplitude of the suspension system component data as a function of frequency, monitoring the amplitude of the suspension system component data within a predetermined frequency range, determining whether the amplitude of the suspension system component data is greater than a predetermined threshold, and, if the amplitude is greater than the predetermined threshold, transmitting a diagnostic notification.

In some aspects, receiving suspension system component data from the vehicle sensor includes receiving one or more of vertical acceleration data and noise data.

In some aspects, the vehicle sensor includes an active noise cancelling microphone.

In some aspects, the vehicle sensor includes an inertial measurement unit including a vertical acceleration sensor.

In some aspects, transmitting a diagnostic notification includes one or more of setting a diagnostic trouble code and displaying a notification.

In some aspects, the method further includes initiating a diagnostic mode of operation upon receipt of a signal indicating that the vehicle is approaching a reference road surface including a plurality of reference input members.

In some aspects, the method further includes segmenting the suspension system component data into one or more windows as a wheel of the vehicle travels over the plurality of reference input members of the reference road surface.

In some aspects, the method further includes comparing the windowed suspension system component data to a baseline suspension system component data to determine if the suspension system component is operating within one or more predetermined thresholds.

In some aspects, the predetermined threshold is one or more of an amplitude threshold, a power threshold, and a decay rate.

In another aspect, a system to detect a wear condition of a suspension component of a vehicle includes at least one vehicle sensor, and an electronic controller in electronic communication with the at least one vehicle sensor. The electronic controller is configured to receive suspension system component data from the vehicle sensor, calculate an amplitude of the suspension system component data as a function of frequency, monitor the amplitude of the suspension system component data within a predetermined frequency range, determine whether the amplitude of the suspension system component data is greater than a predetermined threshold, and, if the amplitude is greater than the predetermined threshold, transmit a diagnostic notification.

In some aspects, transmitting the diagnostic notification includes one or more of setting a diagnostic code and displaying a notification.

In some aspects, the vehicle sensor is a component of an inertial measurement unit including a vertical acceleration sensor.

In some aspects, the suspension system component data is vertical acceleration data.

In some aspects, the vehicle sensor includes an active noise cancelling microphone.

In some aspects, the suspension system component data is noise data.

In some aspects, the vehicle sensor includes a vertical displacement sensor.

In some aspects, the suspension system component data is vertical displacement data.

In some aspects, the controller is further configured to initiate a diagnostic mode of operation upon receipt of a signal indicating that the vehicle is approaching a reference road surface including a plurality of reference input members.

In some aspects, the controller is further configured to segment the suspension system component data into one or more windows as a wheel of the vehicle travels over the plurality of reference input members of the reference road surface and compare the windowed suspension system component data to a baseline suspension system component data to determine if the suspension system component is operating within one or more predetermined thresholds.

In some aspects, the predetermined threshold is one or more of an amplitude threshold, a power threshold, and a decay rate.

### BRIEF DESCRIPTION OF THE DRAWINGS

The present disclosure will be described in conjunction with the following figures, wherein like numerals denote like elements.

FIG. 1 is a schematic diagram of a vehicle having a suspension monitoring system, according to an embodiment.

FIG. 2 is a perspective partial view of a vehicle having a suspension system, according to an embodiment.

FIG. 3 is a front partial view of a vehicle having a system configured to determine whether abnormalities exist in a vehicle suspension system, according to an embodiment.

FIG. 4 is an overhead view of a reference road surface, according to an embodiment.

FIG. 5 is a side view of a reference road surface and a wheel hop/bounce response to travel of the vehicle wheel over the reference road surface, according to an embodiment.

FIG. 6 is a graphical representation of wheel displacement data over time as the wheels of a vehicle travel over the reference road surface, according to an embodiment.

FIG. 7 is a graphical representation of damper response to a road irregularity as a function of time or distance from the road irregularity for dampers of various wear profiles, according to an embodiment.

FIG. 8 is a schematic flow diagram of a method that uses vehicle displacement sensors to determine whether one or more suspension system components, such as one or more vehicle dampers, are functioning properly to provide acceptable vehicle stability, according to an embodiment.

FIG. 9 is a graphical representation of vertical acceleration data of a vehicle suspension due to excitation of a functioning suspension system triggered by travel over a reference road surface, according to an embodiment.

FIG. 10 is a graphical representation and analysis of vertical acceleration data of a vehicle suspension due to excitation of a worn or damaged suspension system triggered by travel over a reference road surface, according to an embodiment.

FIG. 11 is a schematic flow diagram of a method that uses vertical acceleration sensors to determine whether one or more suspension system components, such as one or more vehicle dampers, are functioning properly, according to an embodiment.

FIG. 12 is a graphical representation of noise data obtained from one or more active noise cancelling microphones used to identify suspension component degradation, according to an embodiment.

FIG. 13 is a graphical representation of the amplitude of noise data reflecting suspension component degradation with reference to a specified frequency band, according to an embodiment.

FIG. 14 is a schematic flow diagram of a method that uses active noise cancelling microphones to determine whether one or more suspension system components, such as one or more vehicle dampers, are functioning properly, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

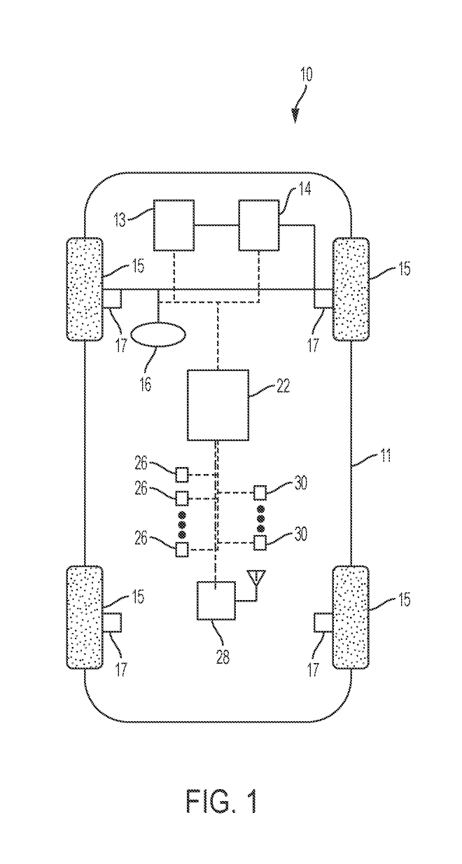

FIG. 1 schematically illustrates an automotive vehicle 10 according to the present disclosure. The vehicle 10 generally includes a body 11 and wheels or tires 15. The body 11 encloses the other components of the vehicle 10. The wheels 15 are each rotationally coupled to the body 11 near a respective corner of the body 11. The vehicle 10 is depicted in the illustrated embodiment as a passenger car, but it should be appreciated that any other vehicle, including motorcycles, trucks, sport utility vehicles (SUVs), or recreational vehicles (RVs), etc., can also be used. In some embodiments, the vehicle 10 is an autonomous or semi-autonomous vehicle. In some embodiments, the vehicle 10 is operated directly by a vehicle operator.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems. The vehicle 10 additionally includes a steering system 16. While depicted as including a steering wheel and steering column for illustrative purposes, in some embodiments, the steering system 16 may not include a steering wheel. The vehicle 10 additionally includes one or more suspension system components, such as vehicle dampers or shock absorbers 17. In some embodiments, as shown in FIG. 1, a vehicle damper 17 is positioned adjacent to each of the wheels 15.

In various embodiments, the vehicle 10 also includes a navigation system 28 configured to provide location information in the form of GPS coordinates (longitude, latitude, and altitude/elevation) to a controller 22. In some embodiments, the navigation system 28 may be a Global Navigation Satellite System (GNSS) configured to communicate with global navigation satellites to provide autonomous geo-spatial positioning of the vehicle 10. In the illustrated embodiment, the navigation system 28 includes an antenna electrically connected to a receiver. In some embodiments, the navigation system 28 provides data to the controller 22 to assist with autonomous or semi- autonomous operation of the vehicle 10.

With further reference to FIG. 1, the vehicle 10 also includes a plurality of sensors 26 configured to measure and capture data on one or more vehicle characteristics, including but not limited to vehicle speed, tire pressure and/or acceleration (including vertical acceleration), noise or sound, vertical displacement, and vehicle acceleration. In the illustrated embodiment, the sensors 26 include, but are not limited to, an accelerometer, a speed sensor, a tire pressure/acceleration monitoring sensor, a displacement sensor (such as, for example and without limitation, a lower control arm displacement sensor), an acceleration sensor (such as, for example and without limitation, a lower control arm acceleration sensor and/or an upper mount acceleration sensor), an active noise cancellation (ANC) microphone, gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, light level detection sensors, and/or additional sensors as appropriate. In some embodiments, the vehicle 10 also includes a plurality of actuators 30 configured to receive control commands to control steering, shifting, throttle, braking or other aspects of the vehicle 10.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

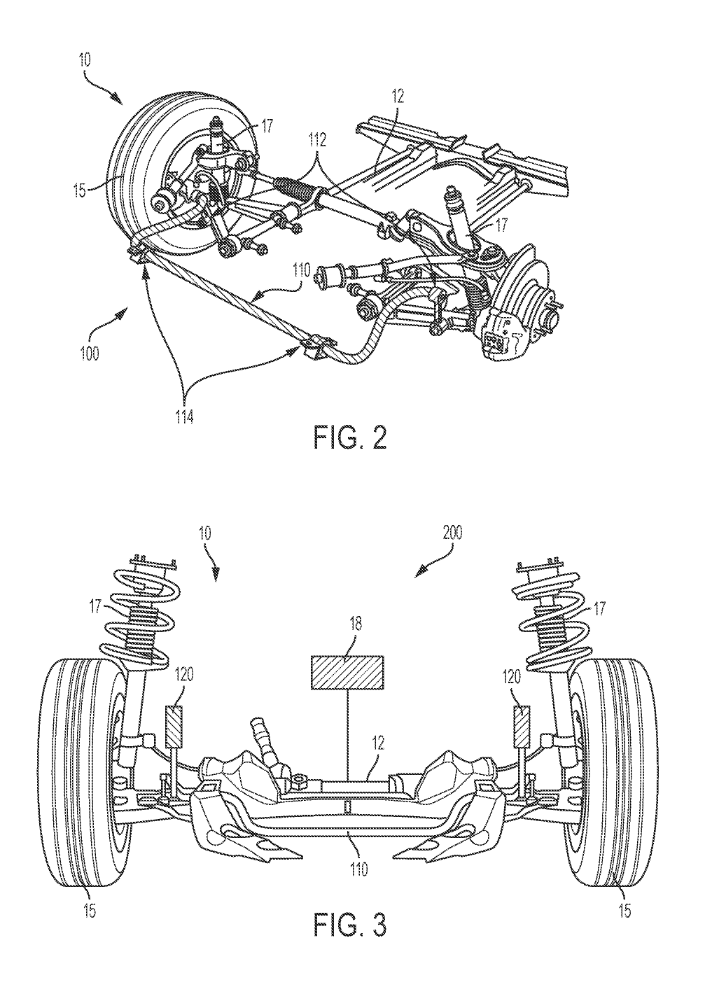

The vehicle, such as the vehicle 10 partially shown in FIG. 2, includes a chassis 12, an axle 13, and at least one wheel 15. One or more suspension components may form a suspension system 100 coupled to the chassis 12 and/or the axle 13 near the wheels 15. The suspension system 100 includes, in some embodiments, one or more dampers 17 configured to dampen the effect of road- induced vibrations, such as those caused by irregular road surfaces, etc. The suspension system 100 also includes, in some embodiments, one or more stabilizer system components including a stabilizer or sway bar 110, one or more sway bar links 112, and one or more sway bar bushings 114. Throughout this disclosure, the terms “stabilizer” and “sway” are used interchangeably. The sway bar 110 helps to reduce the body roll of the vehicle 10 during fast cornering or over road irregularities. The sway bar 110 connects opposite (left/right) wheels 16 together through short lever arms linked by a torsion spring. The sway bar 110 increases the roll stiffness of the suspension system 100, that is, its resistance to roll in turns, independent of its spring rate in the vertical direction. Failure or wear in any of the suspension system components, including but not limited to the vehicle dampers 17, the sway bar 110, the sway bar links 112, and the sway bar bushings 114, can lead to issues with vehicle stability, as well as increased vehicle noise.

As shown in FIG. 3, the vehicle 10 includes a suspension monitoring system 200. In some embodiments, the system 200 includes one or more sensors 120. The sensors 120 include, for example and without limitation, lower control arm displacement or acceleration sensors and upper mount acceleration sensors. The sensors 120 measure a displacement and/or acceleration of one or more of the components of the suspension system 100 of the vehicle 10. The sensors 120 are electronically connected to a vehicle controller, such as the controller 22, as discussed in greater detail herein. In some embodiments, the vehicle corner displacements and/or body roll is determined from data received from other vehicle sensors/accelerometers.

Additionally or alternatively, in some embodiments, the suspension monitoring system 200 of the vehicle 10 includes an inertial measurement unit (IMU) 18. The IMU 18 is coupled to the chassis 12. The IMU 18 is an electronic device that measures and reports the dynamically changing movements of the vehicle using a combination of accelerometers and gyroscopes. The IMU 18 provides a stream of data related to the linear acceleration of the vehicle on three principal axes, together with the three sets of rotation parameters (pitch, role, and heading) to a vehicle controller, such as the controller 22, as discussed in greater detail herein. In some embodiments, a safety data module (not shown) coupled to the vehicle 10 also includes sensors capable of measuring the lateral acceleration of the vehicle 10. The safety data module is also electronically connected to the vehicle controller to transmit sensor data for further analysis and calculation, as discussed in greater detail herein.

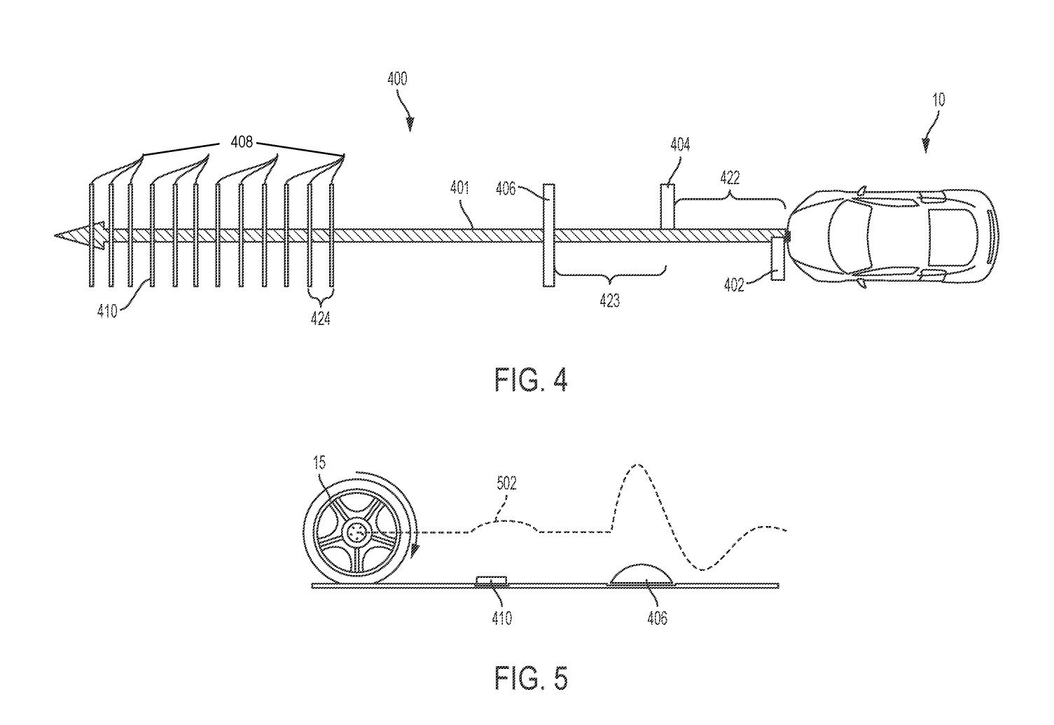

Using a measured and calibrated “reference” road surface, suspension components, such as the components of the suspension system 100, can be diagnosed for state of health. FIG. 4 illustrates one embodiment of a reference road surface 400. The road surface 400 includes reference input members, such as, for example and without limitation, bumps and ridges, that are resilient to vehicle usage and maintain their original shapes as the vehicle 10 passes over them. In some embodiments, the reference input members are approximately parallel to each other and approximately perpendicular to the vehicle's path of travel to provide consistent excitation of the vehicle wheels. As shown in FIG. 4, a first input member 402 is oriented to the left of a center line of travel 401 of the vehicle 10. The left side wheels 15 of the vehicle 10 pass over the first input member 402 as the vehicle 10 travels along the line of travel 401. Similarly, a second side input member 404 is oriented to the right of the center line of travel 401. The right side wheels 15 of the vehicle 10 pass over the second side input member 404 as the vehicle 10 travels along the line of travel 401.

A third input member 406 extends across (that is, it is approximately perpendicular to) the center line of travel 401 and extends approximately equidistant to each side of the center line of travel 401. The third input member 406 allows the front wheels 15 of the vehicle 10 to pass over the third input member 406 at approximately the same time, while the rear wheels 15 of the vehicle 10 pass over the third input member 406 at a later time.

The first input member 402 and the second side input member 404 are separated by a first separating distance 422. The second side input member 404 and the third input member 406 are separated by a second separating distance 423. In some embodiments, the first separating distance 422 and the second separating distance 423 are approximately equal. In some embodiments, the first separating distance 422 is less than the second separating distance 423 and vice versa.

In some embodiments, the reference road surface 400 includes a fourth set of input members 408. The fourth set of input members 408 includes a series of individual input members 410 aligned approximately parallel to each other and extending perpendicular to the center line of travel 401. Similar to the third input member 406, each individual member of the fourth set of input members 408 extends approximately equidistant to each side of the center line of travel 401 such that the front wheels 15 of the vehicle 10 are excited by the input at approximately the same time, followed by the rear wheels 15 of the vehicle 10, which are similarly excited by the input at approximately the same time. The individual inputs 410 of the fourth set of inputs 408 are separated by a spacing distance 424. In some embodiments, the spacing distance 424 is less than the spacing distance 422 and/or the spacing distance 423. In some embodiments, the spacing distances 422, 423, 424 are approximately consistent wherever the reference road surface 400 is installed, such as, for example and without limitation, at a dealership or vehicle service area, to provide consistent testing results, as discussed in greater detail herein.

In some embodiments, the reference input members 402, 404, 406, 410 comprise several types of shapes to drive or excite the components of the suspension system 100 at different rates. As shown in FIG. 5, in some embodiments, the shape of the reference input member 406 drives a larger suspension excitation (illustrated by line 502) than the shape of the reference input member 410. It is known that vehicle dampers function with different levels of resistance at a varying input velocities. The vehicle 10 can be driven across the reference road surface 400 at predetermined speeds to trigger excitation to the vehicle suspension system 100 at predicable vertical input velocities. In some embodiments, the reference input members 402, 404, 406, 410 are shaped and placed within the reference road surface 400 to excite the suspension system 100 at vertical velocities in the range of low speed damper velocities and mid speed damper velocities. In some embodiments, the reference input members 402, 404, 406, 410 can be placed with multiple and different spacing distances or intervals to induce worst case “wheel hop” inputs. The reference road surface 400 provides a consistent and repeatable input surface to evaluate and diagnose abnormalities or irregularities in one or more of the components of the suspension system 100, as discussed in greater detail herein. As illustrated in FIGS. 4 and 5, the vehicle 10 can travel in either direction over the input members of the reference road surface 400.

Monitoring Vehicle Dampers Using Displacement Sensors

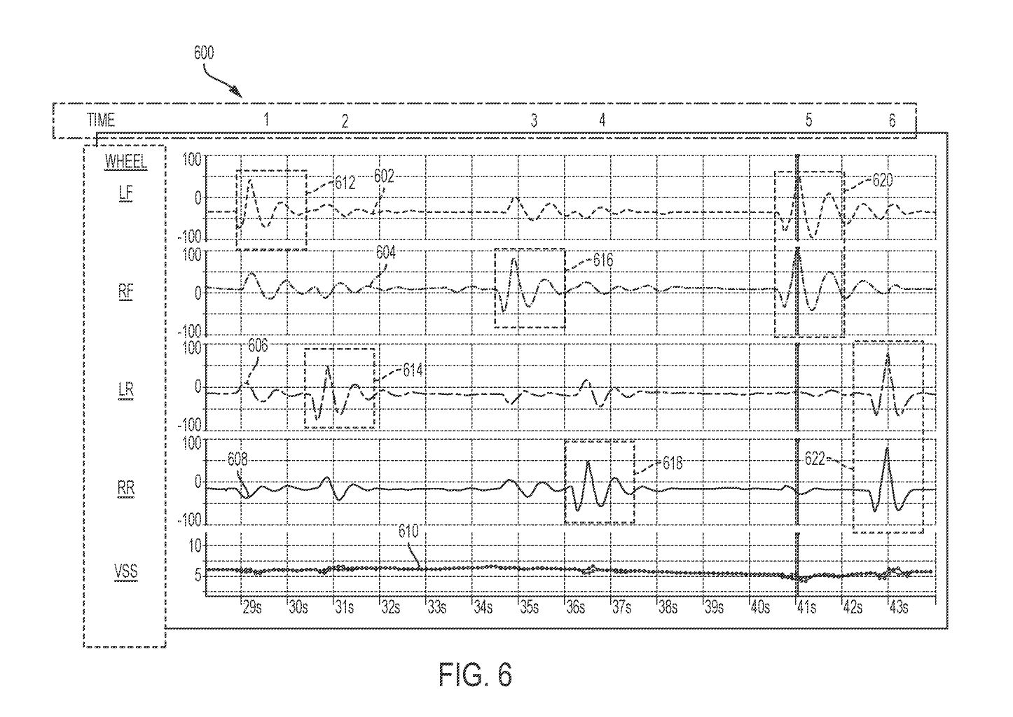

With reference to FIG. 6, vehicle travel over the input members 402, 404, 406, 410 of the reference road surface 400 trigger excitations in the suspension system 100. Due to the placement of the input members 402, 404, 406, 410, the timing of the suspension excitations at each wheel position are discrete and predictable based on the vehicle speed. Displacement sensors at each corner of the vehicle adjacent to each wheel 15, such as the sensors 120 shown in FIG. 3, measure the vertical displacement and/or acceleration of the suspension system at the wheel 15. Each of the displacement sensors 120 generates a data signal indicating the vertical displacement and/or acceleration at the associated wheel 15. As shown in FIG. 6, the sensor 120 adjacent to the left front wheel 15 of the vehicle 10 generates the signal 602. Similarly, the sensor 120 adjacent to the right front wheel 15 generates the signal 604, the sensor 120 adjacent to the left rear wheel 15 generates the signal 606, and the sensor 120 adjacent to the right rear wheel 15 generates the signal 608. The signals 602, 603, 606, 608 are electronically transmitted to the controller 22 for further analysis, as discussed herein. A vehicle speed sensor, such as one of the sensors 26, generates a vehicle speed signal 610 that is also transmitted to the controller 22 for use with analysis of the displacement and/or acceleration signals 602, 604, 606, 608.

At a time 1, the left front wheel 15 of the vehicle 10 travels over an input member of the reference road surface 400, such as the first input member 402, triggering the excitation in the signal 602 shown in box 612. At time 2, as the vehicle 10 continues progress along the reference road surface 400, the left rear wheel 15 travels over the first input member 402, triggering the excitation in the signal 606 shown in box 614. With continued progress along the reference road surface 400, at time 3, the right front wheel 15 travels over the second input member 404, triggering the excitation in the signal 604 shown in box 616, followed at time 4 by excitation in the signal 608 shown in box 618 as the right rear wheel 15 travels over the second input member 404. At time 5, excitation in both the left and right front wheels 15 is indicated in the signals 602, 604 shown in box 620 as the left and right front wheels 15 travel over the third input member 406. Similarly, at time 6, excitation in both the left and right rear wheels 15 is indicated in the signals 606, 608 shown in box 622 as the left and right rear wheels 15 travel over the third input member 406. The controller 22 receives each of the signals 602, 604, 606, 608, along with the vehicle speed signal 610, and determines whether the signals indicate an abnormality within the suspension system 100.

In some embodiments, the signals 602, 604, 606, 608 are compared directly to each other to determine a relative damper condition. In some vehicle applications, front and rear vehicle damper settings may be proportional. Therefore, in some embodiments, for example, the response measured from the front wheel 15 versus the response measured from the rear wheel 15 can indicate whether the front or rear damper 17 is not performing within an acceptable performance range.

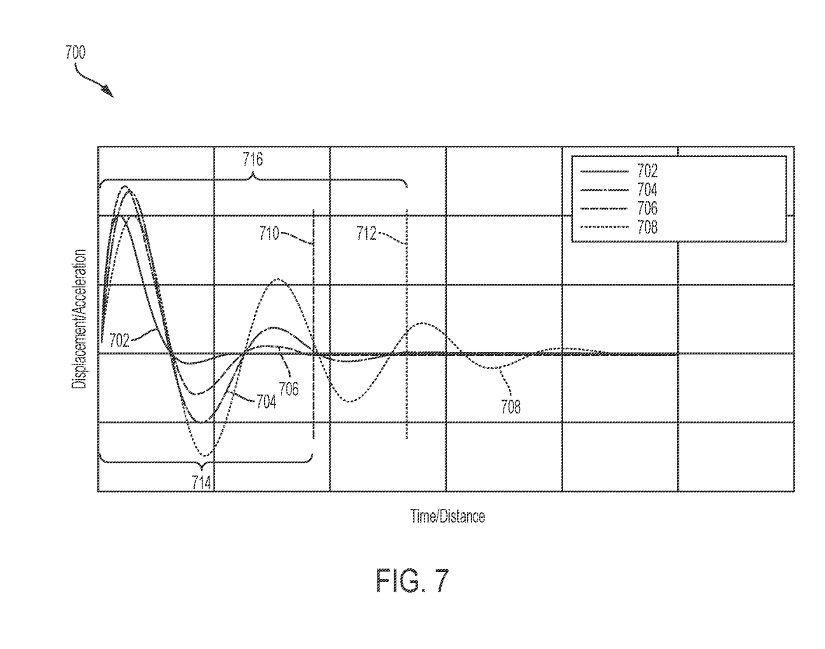

An indication of vehicle damper condition, such as the condition of one or more of the vehicle dampers 17, is depicted graphically in FIG. 7. FIG. 7 illustrates the vertical displacement or acceleration of the suspension due to excitation from travel over one of the input members 402, 404, 406, 410 of the reference road surface 400. For a tire with a functional damper 17, the displacement or acceleration signal shown as line 702 has an initial peak when the tire goes over the input member but after the initial peak the excitation quickly attenuates due to the damping effects of the vehicle damper 17. In contrast, a leaking damper 17 results in a displacement or acceleration signal 704 having multiple peaks and a longer distance/time until the excitation attenuates. Similarly, and more dramatically, for a moderately worn (signal 706) and a completely worn (708) vehicle damper 17, the signals 706, 708 each have an initial peak as well as several peaks over a greater distance/time, with attenuation occurring at a much further distance/time from the time of travel over the input member.

Each of the signals 702, 704, 706, 708 are evaluated, by the controller 22, against a first decay threshold 710 and a second decay threshold 712. The first decay threshold 710 defines a first decay limit 714. The first decay limit 714 is expressed in either time elapsed or distance traveled from the input member. If the signal 702, 704, 706, 708 attenuates below a predetermined threshold within the first decay limit 714, the signal indicates acceptable performance (that is, within acceptable tolerances) of the associated vehicle damper 17. If, however, the signal 702, 704, 706, 708 has not attenuated below the predetermined threshold prior to the first decay threshold 710, the controller 22 can notify the vehicle operator and/or trigger a diagnostic code. In some embodiments, the predetermined threshold is a predetermined number of excitation peaks measured within the decay time/distance limit 714. In some embodiments, the predetermined number of excitation peaks is 3, however, in other embodiments, the predetermined number of excitation peaks is more or less than 3.

The second decay threshold 712 defines a second decay limit 716. The second decay limit 716 is similarly expressed in either a time elapsed or distance traveled from the input member. If excitation peaks exist in the signal 702, 704, 706, 708 beyond the limit 716 or a height of the excitation peak measured at the second decay threshold 712 is above a predetermined threshold, the controller 22 can notify the operator of a possible failure of the vehicle damper 17 and/or trigger a diagnostic code directing replacement of the vehicle damper 17.

In some embodiments, the Fast Fourier Transform (FFT) of each of the signals 602, 604, 606, 608 or the signals 702, 704, 706, 708 is performed such that the energy of the excitation measured by one of the sensors 120 may be compared to recent historical displacement and/or acceleration measurements from the same sensor 120 to determine whether damper performance has changed over time. In some embodiments, the signals 602, 604, 606, 608 or 702, 704, 706, 708 are analyzed within a predetermined frequency band such that excitations above a predetermined threshold within the predetermined frequency band trigger notification to the vehicle operator and/or setting a diagnostic code, for example and without limitation.

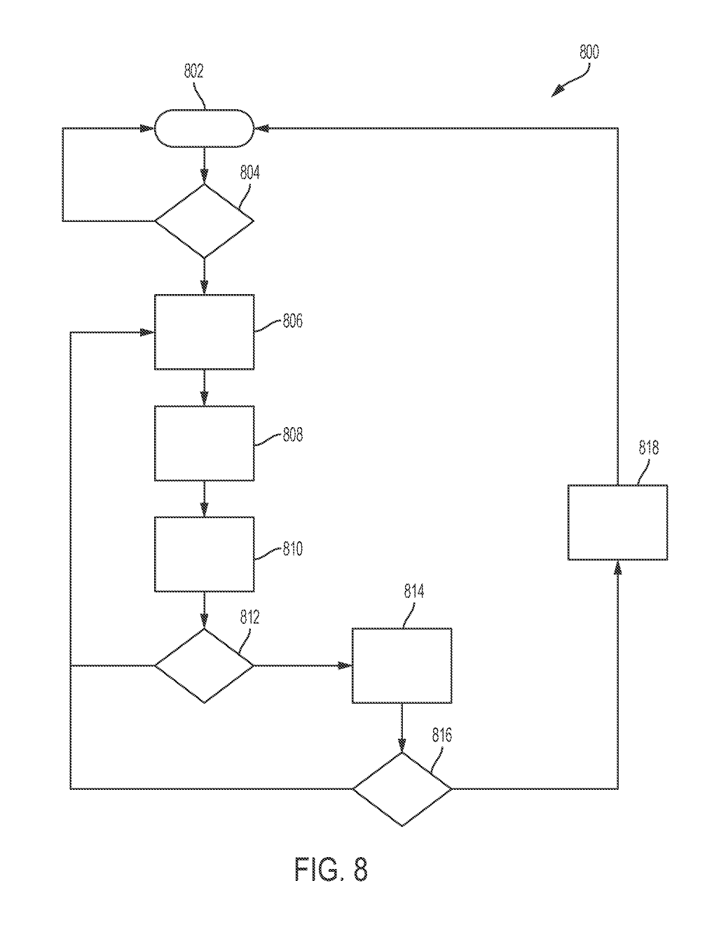

FIG. 8 illustrates a method 800 to determine whether one or more suspension system components, such as one or more of the vehicle dampers 17, is functioning properly to provide acceptable vehicle stability. The method 800 can be utilized in connection with a vehicle having one or more sensors 26, and corner displacement and/or acceleration sensors 120, such as the vehicle 10. In some embodiments, the method 800 can be utilized in connection with a controller 22 or vehicle electronic control unit (ECU) as discussed herein, or by other systems associated with or separate from the vehicle 10, in accordance with exemplary embodiments. The order of operation of the method 800 is not limited to the sequential execution as illustrated in FIG. 8 but may be performed in one or more varying orders, or steps may be performed simultaneously, as applicable in accordance with the present disclosure. The method 800 may be performed as the vehicle 10 travels over a reference road surface 400 or may be performed during vehicle operation along any type of road surface.

As shown in FIG. 8, the method 800 starts at 802 and proceeds to 804. At 804, the controller 22 determines whether the vehicle 10 is moving. For example, in some embodiments, a vehicle speed sensor, one of the sensors 26, associated with the controller 22 determines whether the vehicle speed is above a predetermined threshold, such as, for example and without limitation, 3 kph. If the vehicle speed is not above the predetermined threshold, the method 800 returns to the start at 802. If the vehicle 10 speed is above the predetermined threshold, the method 800 proceeds to 806.

At 806, the controller 22 receives displacement and/or acceleration data from one or more of the sensors 120. In some embodiments, a semi-active damping system module or a real time damping module of the controller 22 records the displacement and/or acceleration data received from the sensors 120 via, for example and without limitation, a CAN bus or via a wireless transmission.

Next, at 808, the controller 22 transforms the time- or distance-based displacement and/or acceleration signals received from the sensors 120 to a frequency domain signal using, for example, bandpass filtering or a Fast Fourier Transform. At 810, the controller 22 continuously monitors the energy of the signals 602, 604, 606, 608. In some embodiments, the signals 602, 604, 606, 608 are monitored with respect to the decay limits 714, 716. In some embodiments, the signals 602, 604, 606, 608 are monitored with respect to a predetermined frequency band.

Next, at 812, the controller 22 analyzes the peak of each signal(s) and determines whether the peak exceeds a predetermined threshold, whether the monitored signal(s) exceeds a predetermined decay rate (as defined by the decay limits 714, 716), and/or the FFT power exceeds a predetermined threshold. If the monitored signal(s) does not exceed the threshold, the method 800 returns to 806 and the method 800 proceeds as discussed herein.

However, if the peak of at least one of the monitored signals is greater than the predetermined threshold, at least one of the monitored signals exceeds the predetermined decay rate, and/or the FFT power of at least one of the monitored signals exceeds the predetermined threshold, the method 800 proceeds to 814. At 814, the controller 22 increases a fault counter by one. The controller 22 maintains a count of fault signals that indicate a possible suspension issue, such as an excessively worn vehicle damper 17. That is, the controller 22 maintains a count of signals that exceed the predetermined thresholds discussed herein. The controller 22 identifies the signals received from each sensor 120 such that any identified suspension issues can be associated with a specific damper 17.

After increasing the fault counter, the method 800 proceeds to 816. At 816, the controller 22 monitors the fault counter to determine if the count of fault signals is above a predetermined maximum fault count. In some embodiments, for example, the predetermined maximum fault count is 10 occurrences over a predetermined interval, such as, for example and without limitation, the last 10 miles of vehicle operation or within a single key cycle. In other embodiments, the predetermined oscillation count over the predetermined threshold could be more or fewer than 10, such as, for example and without limitation, 5, 8, 12, 15, or more occurrences over a specified time and/or distance interval. As discussed herein, a signal that does not attenuate within either of the decay limits 714, 716, a signal having a power that exceeds a predetermined threshold, and/or a signal having a peak above a predetermined threshold indicates a possible issue with one or more of the vehicle dampers 17, such as, for example and without limitation, a worn or leaking damper.

If the fault counter is above the predetermined maximum fault count, the method 800 proceeds to 818 and the controller 22 transmits a diagnostic notification, such as, for example and without limitation, an indication of a possible vehicle damper issue. In some embodiments, transmitting the diagnostic notification includes setting a diagnostic trouble code (DTC), transmitting a diagnostic code via a wireless communication system, or displaying a notification to the vehicle operator. In some embodiments, the vehicle operator is notified of the potential issue and may be instructed to direct the vehicle to a service facility for evaluation and repair or replacement of one or more of the vehicle dampers 17. In some embodiments, the controller 22 may direct and/or control the autonomous or semi-autonomous vehicle to a service facility for evaluation and repair or replacement of one or more of the vehicle dampers 17. In some embodiments, from 818, the method 800 returns to the start at 802 and the method 800 runs continuously.

If the fault counter is not above the predetermined maximum fault count, the method 800 returns to 806 and the method 800 proceeds as discussed herein.

While the signals 602, 604, 606, 608 and 702, 704, 706, 708 are discussed herein as wheel displacement or acceleration responses to input members as part of a reference road surface 400, the method 800 discussed herein may also be used with a vehicle 10 having corner displacement and/or acceleration sensors 120 traveling along any road surface.

Using IMU Sensors to Monitor Suspension Components

In some embodiments, data obtained by the sensors of the IMU 18, in particular sensors detecting the vertical Z acceleration of the vehicle 10, is used to determine the performance condition of one or more suspension components, including one or more of the vehicle dampers 17. In some embodiments, as the vehicle 10 travels over the reference road surface 400, the sensors of the IMU 18 detect the vertical acceleration as each wheel 15 passes over an input member of the reference road surface 400. The vertical acceleration data is analyzed by the controller 22, which detects the sequence of time between input events (that is, for example and without limitation, the time elapsed between the left front wheel passing over the first input member 402 and the left rear wheel passing over the first input member 402) and the response power recorded as each wheel 15 passes over the input member.

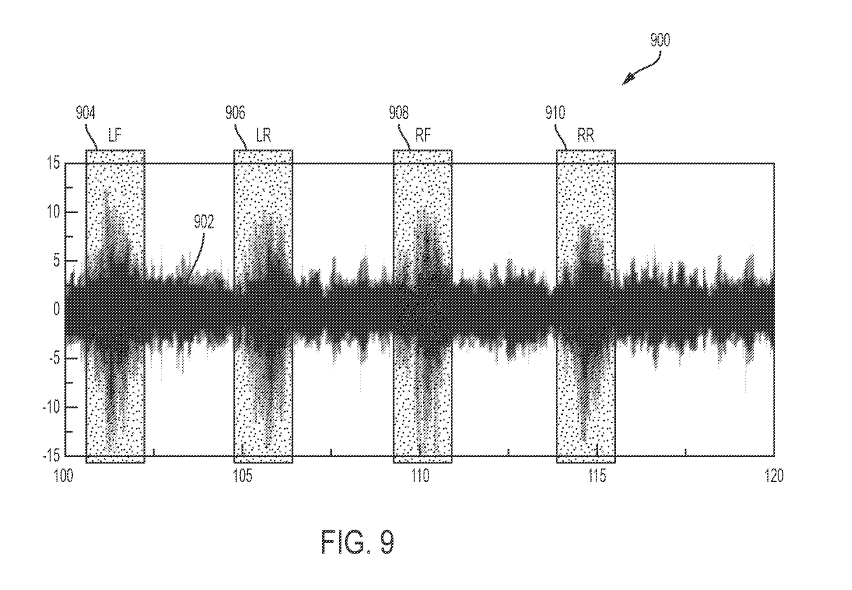

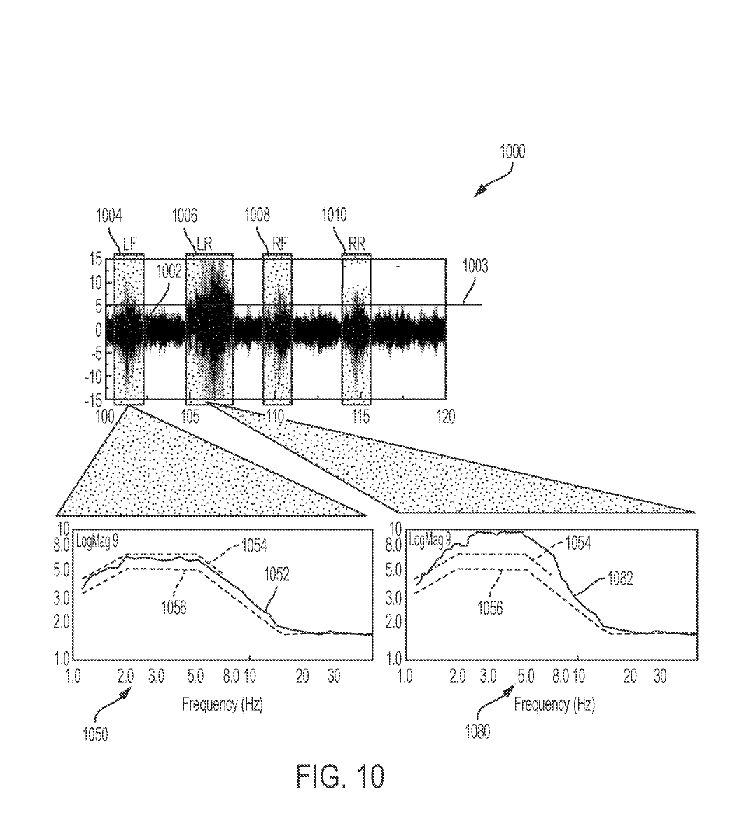

FIG. 9 is a graphical representation 900 of a vertical acceleration signal 902 generated when a vehicle 10 having operational vehicle dampers 17 passes over input members of a reference road surface 400. While the vertical acceleration of the vehicle 10 may be continuously received from the sensors of the IMU 18, in some embodiments, the controller 22 does not begin monitoring the signal 902 until the vehicle 10 has passed over the first input member 402 and the controller 22 continues monitoring the vertical acceleration data signals for a predetermined calibration time period. In some embodiments, the predetermined calibration time period is determined from the vehicle speed, obtained from one of the sensors 26, as well as information regarding the reference road surface 400 including, for example and without limitation, the spacing between the input members 402, 404, 406, 410, etc.

The vertical acceleration signal 902 includes four distinct vertical acceleration responses, highlighted by the windows 904, 906, 908, 910. The first window 904 highlights the vertical acceleration associated with the left front wheel 15 of the vehicle 10 passing over an input member, such as the first input member 402. The second window 906 highlights the vertical acceleration associated with the left rear wheel 15 of the vehicle 10 passing over an input member, such as the first input member 402. The third window 908 highlights the vertical acceleration associated with the right front wheel 15 of the vehicle 10 passing over an input member, such as the second input member 404. The fourth window 910 highlights the vertical acceleration associated with the right rear wheel 15 of the vehicle 10 passing over an input member, such as the second input member 404.

The vertical acceleration responses highlighted by the windows 904, 906, 908, 910 can be correlated, by the controller 22, to the vehicle 10 passing over the input members 402, 404 of the reference road surface 400. In some embodiments, a series of expected vertical acceleration responses, such as those shown in FIG. 9, are used to establish a baseline performance of the vehicle dampers 17. The baseline signal, such as the signal 902, may be compared to other vertical acceleration response signals to determine the condition of one or more of the vehicle dampers 17.

FIG. 10 is a graphical representation 1000 of a vertical acceleration signal 1002 generated when the vehicle 10, having one or more vehicle dampers 17, passes over input members 402, 404 of a reference road surface 400. While the vertical acceleration of the vehicle 10 may be continuously received from the sensors of the IMU 18 and monitored by the controller 22, in some embodiments, the controller 22 does not begin recording the signal 1002 until the vehicle 10 has passed over the first input member 402 and the controller 22 continues recording the vertical acceleration data signals for a predetermined calibration time period. In some embodiments, the controller 22 begins recording the signal 1002 when the signal exceeds a threshold vertical acceleration limit 1003. In some embodiments, the predetermined calibration time period is determined from the vehicle speed, obtained from one of the sensors 26, as well as information regarding the reference road surface 400 including, for example and without limitation, the spacing between the input members, etc.

The vertical acceleration signal 1002 includes four distinct vertical acceleration responses, highlighted by the windows 1004, 1006, 1008, 1010. The first window 1004 highlights the vertical acceleration associated with the left front wheel 15 of the vehicle 10 passing over an input member, such as the first input member 402. The second window 1006 highlights the vertical acceleration associated with the left rear wheel 15 of the vehicle 10 passing over an input member, such as the first input member 402. The third window 1008 highlights the vertical acceleration associated with the right front wheel 15 of the vehicle 10 passing over an input member, such as the second input member 404. The fourth window 1010 highlights the vertical acceleration associated with the right rear wheel 15 of the vehicle 10 passing over an input member, such as the second input member 404.

The vertical acceleration responses highlighted by the windows 1004, 1006, 1008, 1010 can be correlated, by the controller 22, to the vehicle 10 passing over the input members 402, 404 of the reference road surface 400. As shown in FIG. 10, the response highlighted by the window 1006 has a greater magnitude and duration than responses highlighted by the windows 1004, 1008, 1010. Further, comparing the signal 1002 to the signal 902, the response for the left rear wheel 15 in the signal 1002 is greater in magnitude and duration than the baseline signal 902, indicating a possible issue with the damper 17 associated with the left rear wheel 15.

The portions of the signal 1002 highlighted by the windows 1004 and 1006 (that is, the time- or distance-based vertical acceleration responses generated when the left front and the left rear wheels pass over an input member) are transformed into the frequency-domain signal using, for example, a fast Fourier transform (FFT) or a power spectral density. Graphs 1050 and 1080 illustrate the frequency-domain signals for the left front wheel 15 and the left rear wheel 15, respectively. The signal 1052 represents the frequency-domain representation of the vertical acceleration response recorded when the left front wheel 15 of the vehicle 10 travels over the input member. The signal 1082 represents the frequency-domain representation of the vertical acceleration response recorded when the left rear wheel 15 of the vehicle 10 travels over the input member. Represented in the frequency domain, each of the signals 1052, 1082 represent the energy generated by the vehicle's travel over the input member.

In some embodiments, the signals 1052, 1082 are compared against upper and lower limits 1054, 1056. The upper and lower limits 1054, 1056 are predetermined based on the vehicle type, configuration, weight, damper size, etc., for example and without limitation, and define the range of acceptable energy indicative of a functioning vehicle damper 17. Additionally, in some embodiments, the upper and lower limits 1054, 1056 define limits on the time duration of the excitation response, that is, the decay rate of the signal. If the signal fits within the maximum energy and also satisfies the decay rate limits, the signal is indicative of a vehicle damper 17 having acceptable performance.

As shown in graph 1050, the signal 1052 fits within the upper and lower limits 1054, 1056. Therefore, the vertical acceleration data indicates that the vehicle damper 17 associated with the left front wheel 15 is operating within acceptable tolerances and is not overly worn, for example and without limitation.

However, the signal 1082 exceeds both of the upper and lower limits 1054, 1056. Therefore, the vertical acceleration data indicates that the vehicle damper 17 associated with the left rear wheel 15 is not performing within an acceptable, predetermined range and may be overly worn, with either repair or replacement indicated. Based on analysis of this data, the controller 22 generates one or both of a notification to the vehicle operator and sets a diagnostic code, for example and without limitation.

While not illustrated in FIG. 10, the controller 22 performs a similar analysis and comparison of the portions of the signal 1002 highlighted by the windows 1008, 1010 which represent the vertical acceleration response of the vehicle 10 when the right front and right rear wheels travel over the input member.

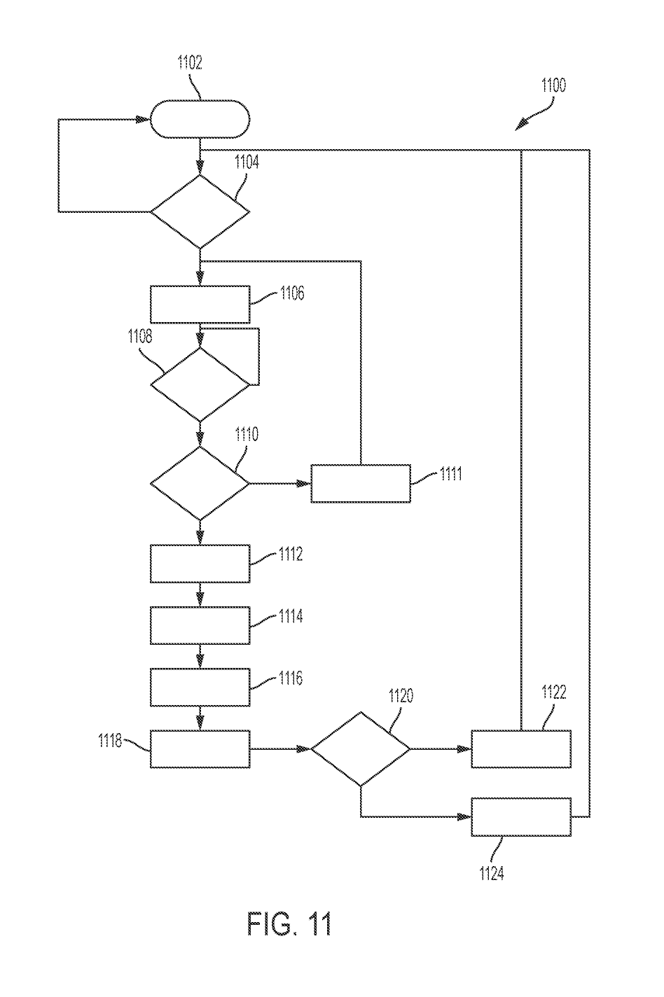

FIG. 11 illustrates a method 1100 to determine whether one or more suspension system components, such as one or more of the vehicle dampers 17, is functioning properly to provide acceptable vehicle stability. The method 1100 can be utilized in connection with a vehicle having one or more sensors 26, and an IMU 18, such as the vehicle 10. The method 100 can be utilized with a vehicle 10 traveling over a reference road surface, such as the reference road surface 400 illustrated in FIG. 4. In some embodiments, the method 1100 can be utilized in connection with a controller 22 or vehicle electronic control unit (ECU) as discussed herein, or by other systems associated with or separate from the vehicle 10, in accordance with exemplary embodiments. The order of operation of the method 1100 is not limited to the sequential execution as illustrated in FIG. 11 but may be performed in one or more varying orders, or steps may be performed simultaneously, as applicable in accordance with the present disclosure.

As shown in FIG. 11, the method 1100 starts at 1102 and proceeds to 1104. At 1104, the controller 22 determines whether to initiate a diagnostic mode of operation of the vehicle 10. If the controller 22 receives a signal, such as a signal from a remote operator via a wireless communication system, indicating that the vehicle 10 is approaching a reference road surface, such as the reference road surfaces 400, the controller 22 will initiate the diagnostic mode of operation for the duration of the vehicle's travel over the reference road surface 400. If the controller 22 initiates the diagnostic mode of operation, the method 1100 proceeds to 1106. However, if the diagnostic mode of operation is not initiated, the method 1100 returns to the start at 1102.

At 1106, the controller 22 begins recording data received from the IMU 18, including vertical acceleration data. Next, at 1108, the controller 22 determines whether the vertical acceleration data received from the IMU 18 exceeds a threshold vertical acceleration limit, such as the threshold vertical acceleration limit 1003. The threshold vertical acceleration limit 1003 is defined, in some embodiments, based on considerations such as the vehicle type, configuration, weight, vehicle damper size, etc.

If the data received from the IMU 18 does not exceeds the threshold vertical acceleration limit 1003, the method 1100 stays at 1108. However, if the data exceeds the threshold vertical acceleration limit 1003, the method 1100 proceeds to 1110.

At 1110, the controller 22 determines whether the vehicle speed is within a predetermined speed window. In some embodiments, the predetermined speed window is defined with respect to considerations such as the vehicle type, configuration, weight, vehicle damper size, and configuration of the reference road surface, for example and without limitation. In some embodiments, the vehicle speed is received from one of the sensors 26. If the vehicle speed is not within the predetermined speed window, the method 1100 proceeds to 1111 and the controller 22 generates a notification that the vehicle 10 should repeat travel over the reference road surface 400 to reinitiate the analysis at a vehicle speed within the predetermined speed window. The method 1100 returns to 1106.

If the vehicle speed is within the predetermined speed window, the method 1100 proceeds to 1112. At 1112, the controller 22 records the vertical acceleration data received from the IMU 18 for the predetermined calibration time period such that vertical acceleration data is measured as each of the four vehicle wheels 15 pass over one or more of the input members 402, 404, 406, 410.

Next, at 1114, the controller 22 analyzes the data, such as the signals 902, 1002 and segments the data into four distinct windows, such as the windows 1004, 1006, 1008, 1010, based on the known configuration of the reference road surface 400, as well as the vehicle speed, to identify the data received as each wheel 15 passes over the input member. At 1116, the controller 22 further analyzes the data, such as the signals 902, 1002, to determine the amplitude peaks within the windows.

Next, at 1118, the controller 22 transforms the time- or distance-based vertical acceleration signals received from the IMU 18 to a frequency domain signal using, for example, a Fast Fourier Transform (FFT). At 1120, the controller 22 continuously monitors the energy of the transformed signal, such as the signals 1052, 1082. The controller 22 analyzes the peak of each signal(s) and determines whether the peak exceeds a predetermined threshold, whether the monitored signal(s) exceeds a predetermined decay rate (as defined by the upper and lower limits 1054, 1056), and/or the FFT power exceeds a predetermined threshold. If the monitored signal(s) does not exceed the threshold, the method 1100 proceeds to 1122 and the controller 22 transmits a diagnostic notification, such as, for example and without limitation, a message displayed to the vehicle operator or technician that the data indicates that the suspension components are performing within acceptable limits. The method 1100 then returns to 1104 and proceeds as discussed herein.

However, if the peak of at least one of the monitored signals is greater than the predetermined threshold, at least one of the monitored signals exceeds the predetermined decay rate, and/or the FFT power of at least one of the monitored signals exceeds the predetermined threshold, the method 1100 proceeds to 1124. At 1124, the controller 22 transmits a diagnostic notification, such as, for example and without limitation, an indication of a possible suspension component issue, such as a vehicle damper issue. In some embodiments, transmitting the diagnostic notification includes setting a diagnostic trouble code (DTC), transmitting a diagnostic code via a CAN bus or wireless communication system, or displaying a notification to the vehicle operator. In some embodiments, the vehicle operator or a technician is notified of the potential issue and may be instructed to direct the vehicle to a service facility for evaluation and repair or replacement of one or more of the vehicle dampers 17. In some embodiments, the controller 22 may direct and/or control the autonomous or semi-autonomous vehicle to a service facility for evaluation and repair or replacement of one or more of the vehicle dampers 17. The method 1100 then returns to 1104 and proceeds as discussed herein.

Monitoring Suspension Component Performance Using ANC Microphones

In some embodiments, data obtained from one or more active noise cancelling (ANC) microphones, one of the sensors 26, is used to determine the performance condition of one or more suspension components, including one or more of the vehicle dampers 17. As the vehicle 10 travels over the reference road surface 400, one or more of the microphones 26 detects sounds with a predetermined frequency characteristic as each wheel 15 passes over an input member 402, 404, 406, 410 of the reference road surface 400. The noise data is analyzed by the controller 22, which detects the sequence of time between input events (that is, for example and without limitation, the time elapsed between the left front wheel passing over the first input member 402 and the left rear wheel passing over the first input member 402) and the noise detected and recorded as each wheel 15 passes over the input member to determine the location and type of suspension component issue, such as, for example and without limitation, an issue with the vehicle damper 17 located adjacent to the left front wheel 15 of the vehicle 10.

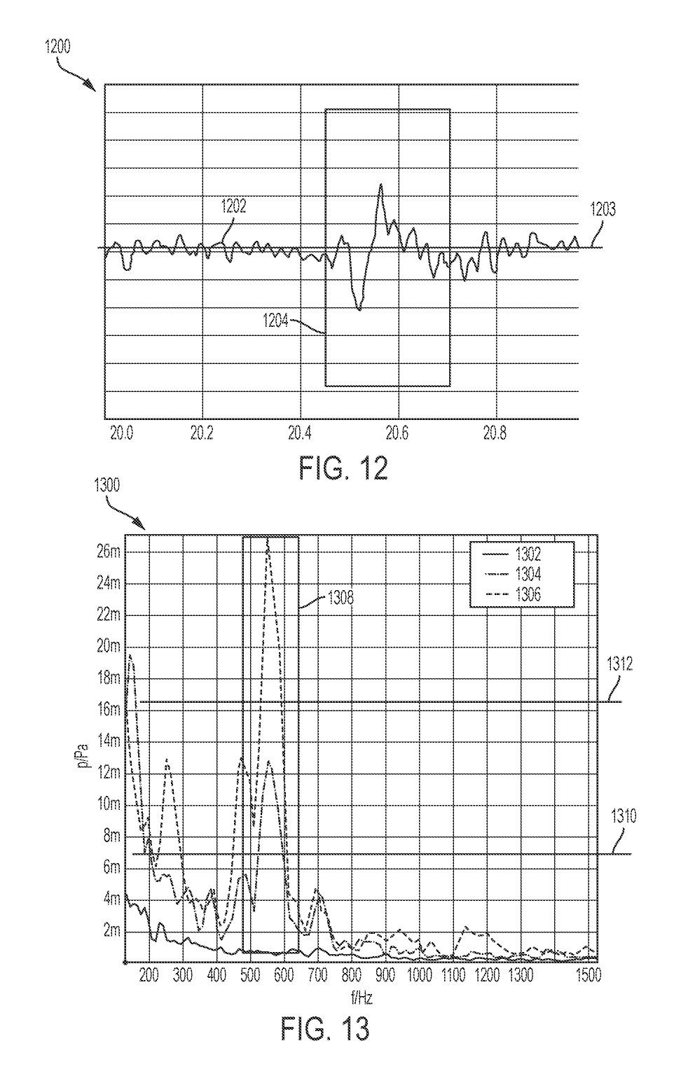

FIG. 12 is a graphical representation 1200 of sound or noise data 1202 received from one or more high fidelity, active noise cancelling (ANC) microphones. The window 1204 highlights the sound peaks recorded when one wheel 15 of the vehicle 10 travels over an input member of the reference road surface, such as the reference road surface 400. For example and without limitation, the window 1204 highlights the sound peaks of the noise data 1202 recorded when the right front wheel 15 travels over the second input member 404 of the reference road surface 400. In some embodiments, the controller 22 begins recording the noise data 1202 once a peak or a series of peaks of the noise data 1202 exceeds a threshold decibel limit 1203.

A data storage module of the controller 22 stores predetermined frequency and sound profile data specific to each component of the suspension system 100. As the at least one high fidelity ANC microphone records noise data as the vehicle 10 travels along the reference road surface, in some embodiments, the noise data can be compared to the stored frequency and sound profile data to determine whether one or more suspension system components is operating within expected parameters. Additionally, because different suspension components produce different noise signals (for example, a loose strut mount produces a different noise signal than a worn vehicle damper), in some embodiments, a comparison of the noise data to the stored frequency and sound profile data is used to identify the worn suspension component. Further, using the time elapsed since the start of the suspension diagnostic test, the reference road surface used for the test, and the vehicle speed during the test, in some embodiments, the noise data can be used to identify the location on the vehicle 10 of the suspension component with a suspected issue.

FIG. 13 is a graphical representation 1300 of the frequency-domain transformation of several noise data signals 1302, 1304, 1306 recorded as one wheel 15 of the vehicle 10 travels over an input member of the reference road surface, such as the input member 404 of the reference road surface 400. The time- or distance-based noise data signal generated when the wheel 15 passes over the input member 404 is transformed into the frequency-domain using, for example, a fast Fourier transform (FFT) or a power spectral density. Graph 1300 illustrates the frequency-domain signals for noise data gathered from a vehicle having a normally-functioning suspension component (signal 1302), a partially-functioning suspension component (signal 1304), and a suspension component that has failed (signal 1306) as one wheel 15, such as, for example, the right front wheel 15, travels over the input member 404. Represented in the frequency domain, each of the signals 1302, 1304, 1306 represent the energy generated by the vehicle's travel over the input member.

The window 1308 highlights a frequency band or range illustrating a worn or underperforming suspension component. Different suspension components produce peaks in different frequency bands as the components wear. Therefore, in some embodiments, the noise data 1302, 1304, 1306 is analyzed by the controller 22 in one or more frequency ranges predetermined based on the suspension components installed on the vehicle 10 and the vehicle type and configuration, among other considerations. Analysis, by the controller 22, of the predetermined frequency bands or ranges of the frequency-domain noise data can target the specific suspension component such that notification of the specific suspension component and/or the location on the vehicle 10 of the underperforming component can be transmitted to the operator or technician. In some embodiments, the controller 22 determines whether one or more peaks of the signals 1302, 1304, 1306 exceeds one or more predetermined thresholds, such as the thresholds 1310, 1312, within the defined frequency band 1308. In some embodiments, the threshold 1310 represents a first threshold indicating a worn suspension component that should be serviced. In some embodiments, the threshold 1312 represents a second threshold indicating a suspension component underperforming such that vehicle stability may be affected and the component should be replaced or repaired.

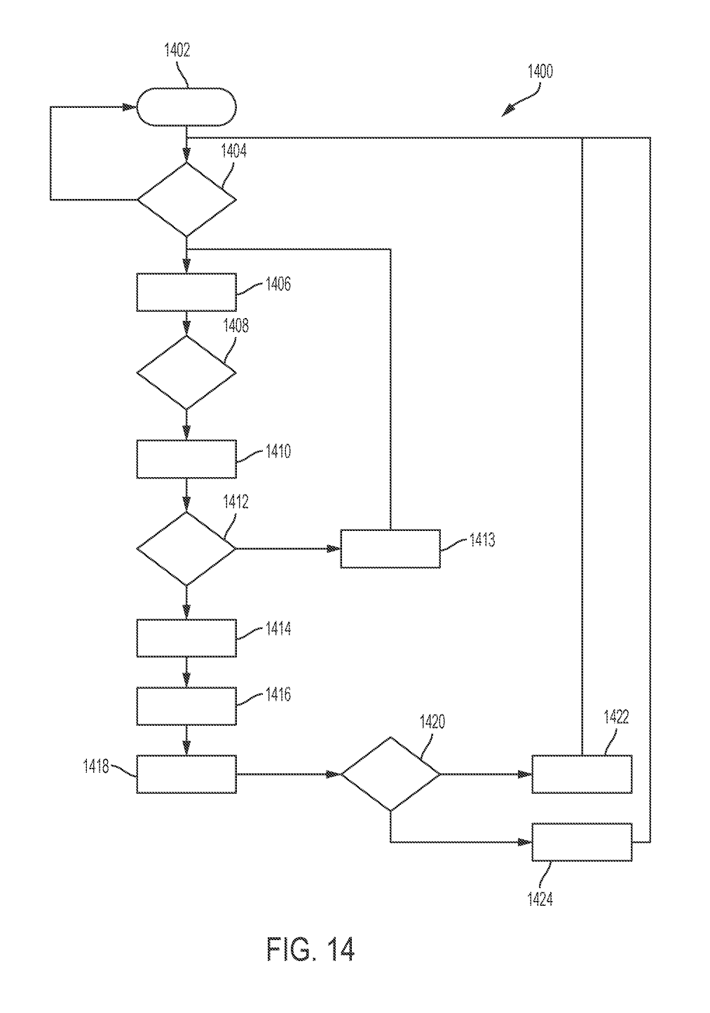

FIG. 14 illustrates a method 1400 to determine whether one or more suspension system components, such as one or more of the vehicle dampers 17, is functioning properly to provide acceptable vehicle stability. The method 1400 can be utilized in connection with a vehicle having one or more sensors 26, including one or more ANC microphones, such as the vehicle 10. In some embodiments, the method 1400 is utilized in connection with a reference road surface, such as the reference road surface 400. In some embodiments, the method 1400 can be utilized in connection with a controller 22 or vehicle electronic control unit (ECU) as discussed herein, or by other systems associated with or separate from the vehicle 10, in accordance with exemplary embodiments. The order of operation of the method 1400 is not limited to the sequential execution as illustrated in FIG. 14 but may be performed in one or more varying orders, or steps may be performed simultaneously, as applicable in accordance with the present disclosure.

As shown in FIG. 14, the method 1400 starts at 1402 and proceeds to 1404. At 1404, the controller 22 determines whether to initiate a diagnostic mode of operation of the vehicle 10. If the controller 22 receives a signal, such as a signal from a remote operator via a wireless communication system or initiation of a diagnostic test from a technician's service tool, indicating that the vehicle 10 is approaching a reference road surface, such as the reference road surface 400, the controller 22 will initiate the diagnostic mode of operation for the duration of the vehicle's travel over the reference road surface. If the controller 22 initiates the diagnostic mode of operation, the method 1400 proceeds to 1406. However, if the diagnostic mode of operation is not initiated, the method 1400 returns to the start at 1402.

At 1406, the controller 22 begins recording noise data received from at least one ANC microphone 26, located, in some embodiments, within the passenger compartment of the vehicle 10. Next, at 1408, the controller 22 determines whether the noise data, such as the signal 1202 received from the ANC microphone 26, exceeds a threshold decibel limit, such as the threshold decibel limit 1203. The threshold decibel limit 1203 is defined, in some embodiments, based on considerations such as the vehicle type, configuration, weight, vehicle damper size, etc., for example and without limitation.

If the noise data received from the ANC microphone does not exceed the threshold decibel limit 1203, the method 1400 remains at 1408. However, if the data exceeds the threshold decibel limit 1203, the method 1400 proceeds to 1410.

At 1410, the controller 22 records the noise data 1202 received from the at least one ANC microphone for a predetermined calibrated time period to capture noise data as each of the four wheels 15 of the vehicle 10 pass over the input members of the reference road surface 400. Next, at 1412, the controller 22 determines whether the vehicle speed is within a predetermined speed window. In some embodiments, the predetermined speed window is defined with respect to considerations such as the vehicle type, configuration, weight, vehicle damper size, suspension system configuration, and configuration of the reference road surface, for example and without limitation. In some embodiments, the vehicle speed is received from a vehicle speed sensor, one of the sensors 26. If the vehicle speed is not within the predetermined speed window, the method 1400 proceeds to 1413 and the controller 22 generates a notification that the vehicle 10 should repeat travel over the reference road surface to reinitiate the analysis at a vehicle speed within the predetermined speed window. Due to the sensitivity of the ANC microphones and the specificity of the stored frequency and sound profile data, the speed of the vehicle 10 as it travels along the reference road surface 400 is an important factor in determining the state of health of one or more of the suspension system components.

If the vehicle speed is within the predetermined speed window, the method 1400 proceeds to 1414. At 1414, the controller 22 analyzes the data, such as the signal 1202, and segments the data into distinct windows based on the known configuration of the reference road surface 400, as well as the vehicle speed, to identify the data received as each wheel passes over the input member. One example of the distinct windows is shown in FIG. 6, for example. The windows may be defined based on time elapsed or distance traveled, for example and without limitation. At 1416, the controller 22 further analyzes the data, such as the signal 1202 to determine the amplitude peaks within the windows.

Next, at 1418, the controller 22 transforms the time- or distance-based noise data signal(s) received from the one or more ANC microphones to a frequency domain signal using, for example, a Fast Fourier Transform. At 1420, the controller 22 continuously monitors the energy of the transformed signal, such as the signals 1302, 1304, 1306. The controller 22 analyzes the peak of each signal(s) and determines whether the peak exceeds a predetermined threshold and/or the FFT power exceeds a predetermined threshold (such as one or more of the thresholds 1310, 1312). If the monitored signal(s) does not exceed the threshold, the method 1400 proceeds to 1422 and the controller 22 transmits a diagnostic notification, such as, for example and without limitation, a message displayed to the vehicle operator or technician that the data indicates that the suspension components are performing within acceptable limits and the vehicle 10 has passed the suspension diagnostic test. The method 1400 then returns to 1404 and proceeds as discussed herein.

However, if the peak of at least one of the monitored signals is greater than the predetermined threshold and/or the FFT power of at least one of the monitored signals exceeds one or both of the predetermined thresholds (such as the first and second thresholds 1310, 1312) within the predetermined frequency band or range, the method 1400 proceeds to 1424. At 1424, the controller 22 transmits a diagnostic notification, such as, for example and without limitation, an indication of a possible suspension component issues, such as a vehicle damper issue or a loose or broken suspension system component. In some embodiments, the notification includes identification of which suspension component is underperforming, and where on the vehicle 10 the underperforming suspension component is located. In some embodiments, transmitting the diagnostic notification includes setting a diagnostic trouble code (DTC), transmitting a diagnostic code via a CAN bus or wireless communication system, or displaying a notification to the vehicle operator. In some embodiments, the vehicle operator or a technician is notified of the potential issue and may be instructed to direct the vehicle to a service facility for evaluation and repair or replacement of one or more of the vehicle dampers 17. In some embodiments, the controller 22 may direct and/or control the autonomous or semi-autonomous vehicle to a service facility for evaluation and repair or replacement of one or more of the vehicle dampers 17. The method 1400 then returns to 1404 and proceeds as discussed herein.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific; embodiments disclosed herein may be combined in different ways to form additional embodiments, all of which fail within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context dearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method to detect a wear condition of a suspension system component of a vehicle, the method comprising:
receiving suspension system component data from a vehicle sensor;
calculating an amplitude of the suspension system component data as a function of frequency;
monitoring the amplitude of the suspension system component data within a predetermined frequency range;
determining whether the amplitude of the suspension system component data is greater than a predetermined threshold; and,
if the amplitude is greater than the predetermined threshold, transmitting a diagnostic notification.

2. The method of claim 1, wherein receiving suspension system component data from the vehicle sensor comprises receiving one or more of vertical acceleration data and noise data.

3. The method of claim 1, wherein the vehicle sensor comprises an active noise cancelling microphone.

4. The method of claim 1, wherein the vehicle sensor comprises an inertial measurement unit comprising a vertical acceleration sensor.

5. The method of claim 1, wherein transmitting a diagnostic notification comprises one or more of setting a diagnostic trouble code and displaying a notification.

6. The method of claim 1, further comprising initiating a diagnostic mode of operation upon receipt of a signal indicating that the vehicle is approaching a reference road surface comprising a plurality of reference input members.

7. The method of claim 6, further comprising segmenting the suspension system component data into one or more windows as a wheel of the vehicle travels over the plurality of reference input members of the reference road surface.

8. The method of claim 7, further comprising comparing the windowed suspension system component data to a baseline suspension system component data to determine if the suspension system component is operating within one or more predetermined thresholds.

9. The method of claim 8, wherein the predetermined threshold is one or more of an amplitude threshold, a power threshold, and a decay rate.

10. A system to detect a wear condition of a suspension component of a vehicle, comprising:
at least one vehicle sensor; and
an electronic controller in electronic communication with the at least one vehicle sensor, the electronic controller configured to
receive suspension system component data from the vehicle sensor;
calculate an amplitude of the suspension system component data as a function of frequency;
monitor the amplitude of the suspension system component data within a predetermined frequency range;
determine whether the amplitude of the suspension system component data is greater than a predetermined threshold; and,
if the amplitude is greater than the predetermined threshold, transmit a diagnostic notification.

11. The system of claim 10, wherein transmitting the diagnostic notification comprises one or more of setting a diagnostic code and displaying a notification.

12. The system of claim 10, wherein the vehicle sensor is a component of an inertial measurement unit comprising a vertical acceleration sensor.

13. The system of claim 12, wherein the suspension system component data is vertical acceleration data.

14. The system of claim 10, wherein the vehicle sensor comprises an active noise cancelling microphone.

15. The system of claim 14, wherein the suspension system component data is noise data.

16. The system of claim 10, wherein the vehicle sensor comprises a vertical displacement sensor.

17. The system of claim 16, wherein the suspension system component data is vertical displacement data.

18. The system of claim 10, wherein the controller is further configured to initiate a diagnostic mode of operation upon receipt of a signal indicating that the vehicle is approaching a reference road surface comprising a plurality of reference input members.

19. The system of claim 18, wherein the controller is further configured to segment the suspension system component data into one or more windows as a wheel of the vehicle travels over the plurality of reference input members of the reference road surface and compare the windowed suspension system component data to a baseline suspension system component data to determine if the suspension system component is operating within one or more predetermined thresholds.

20. The system of claim 19, wherein the predetermined threshold is one or more of an amplitude threshold, a power threshold, and a decay rate.
